(19) United States
(12) Patent Application Publication
(10) Pub. No.: US 2023/0126831 A1
(43) Pub. Date: Apr. 27, 2023

(54) CONTROL PARAMETER OPTIMIZATION DEVICE, PLANT, AND CONTROL PARAMETER OPTIMIZATION METHOD

(71) Applicant: MITSUBISHI HEAVY INDUSTRIES, LTD., Tokyo (JP)

(72) Inventors: Yoshito Nagahama, Yokohama-shi (JP); Takaharu Hiroe, Tokyo (JP); Kazunari Ide, Tokyo (JP); Ryo Sase, Tokyo (JP); Hiroshi Ito, Tokyo (JP); Norikazu Tezuka, Yokohama-shi (JP); Yukihito Okuda, Tokyo (JP); Nobuhiro Osaki, Yokohama-shi (JP); Shota Mochizuki, Yokohama-shi (JP); Shoichiro Hosomi, Yokohama-shi (JP)

(73) Assignee: MITSUBISHI HEAVY INDUSTRIES, LTD., Tokyo (JP)

(21) Appl. No.: 17/801,685

(22) PCT Filed: Feb. 18, 2021
(86) PCT No.: PCT/JP2021/006104

§ 371 Date: Aug. 23, 2022

(30) Foreign Application Priority Data
Feb. 28, 2020 (JP) 2020-033020

(51) Int. Cl. G05B 19/418

(52) U.S. Cl. CPC G05B 19/41835

(57) ABSTRACT

A control parameter optimization device is provided with: a plant model configured to calculate a control command value by a control device and a process quantity of a plant; a control parameter updating unit configured to update a control parameter used for calculating the control command value in the plant model, on the basis of an objective function calculated based on a calculation result of the process quantity in the plant model; and a structural model configured to calculate a clearance between a stationary member and a rotating member in the rotating machine, on the basis of the process quantity from the plant model. The control parameter updating unit is configured to search for an optimal control parameter within a range where the clearance calculated by the structural model satisfies a constraint condition.

### TECHNICAL FIELD

The present disclosure relates to a control parameter optimization device, a plant, and a control parameter optimization method.

The present application claims priority on Japanese Patent Application No. 2020-033020 filed Feb. 28, 2020, the entire content of which is incorporated herein by reference.

### BACKGROUND

In recent years, with the spread of renewable energy, the number of start up and shut down of plants has increased. It is thus required to optimize the operation control of the plant in such a case. The optimal operation control requires, for example, the shortening of start-up time and shut-down time of the plant and the reduction of fuel consumption. The shortening of start-up time of the plant is also important in that it contributes to the reduction of fuel consumption.

Patent Document 1 discloses an operation control optimization device configured to optimize a control parameter of a control device for controlling the operation of a plant. This device inputs a value of the control parameter into a plant model to calculate an objective function such as start-up time, lifetime consumption, and fuel cost, and optimizes the control parameter by adjusting the control parameter so that a difference between the calculated value of the objective function and a target value is minimized.

### Citation List

### Patent Literature

Patent Document 1: JP2017-16353A

### SUMMARY

### Problems to Be Solved

When the start-up time and shut-down time of the plant are shortened, a sudden temperature change occurs, so that thermal stress is generated in a device (e.g., steam turbine) constituting the plant. This thermal stress can be a factor that limits the shortening of start-up time and shut-down time. In response to this, an optimal control parameter for controlling the operation of the plant (particularly, a parameter related to start-up curve or shut-down curve indicating the temporal transition of the amount of power generation or the temporal transition of the opening degree of a main steam valve) is often set on the basis of a predicted value of the thermal stress or a measured value of the temperature and pressure of a working fluid that affects the thermal stress.

However, even in this setting, thermal deformation of the rotating machine is not taken into consideration. The temperature of a rotating member and a stationary member of the rotating machine changes non-uniformly due to non-uniform heat conduction and heat transfer. If a clearance between the rotating member and the stationary member of the rotating machine is reduced due to thermal deformation caused by such a temperature change, damage to parts, wear (aging) of parts, and shaft vibration may occur due to contact between the two. In other words, the risk of damage to the plant increases.

Thus, ensuring a sufficient clearance between the rotating member and the stationary member of the rotating machine can be a factor that limits the shortening of the start-up time and shut-down time as well as the thermal stress. In this regard, Patent Document 1 does not describe a configuration for searching for the control parameter so as to ensure a clearance between the stationary member and the rotating member in the rotating machine.

In view of the above circumstances, an object of the present disclosure is to provide a control parameter optimization device or the like that can search for an optimal control parameter within a range where the clearance between the stationary member and the rotating member in the rotating machine satisfies a constraint condition.

### Solution to the Problems

A control parameter optimization device according to the present disclosure is a device for optimizing a control parameter of a control device for controlling a plant equipped with a rotating machine, comprising: a plant model configured to simulate operation of the entire plant including the control device and calculate a control command value by the control device and a process quantity of the plant; a control parameter updating unit configured to update the control parameter used for calculating the control command value in the plant model, on the basis of an objective function calculated based on a calculation result of the process quantity in the plant model; and a structural model configured to calculate a clearance between a stationary member and a rotating member in the rotating machine, on the basis of the process quantity from the plant model. The control parameter updating unit is configured to search for an optimal control parameter within a range where the clearance calculated by the structural model satisfies a constraint condition.

A plant according to the present disclosure comprises: a rotating machine; the above-described control parameter optimization device; and a control device configured to control operation on the basis of a control parameter optimized by the control parameter optimization device.

A control parameter optimization method according to the present disclosure is a method for optimizing a control parameter of a control device for controlling a plant equipped with a rotating machine, comprising: a step of calculating a control command value by the control device and a process quantity of the plant by using a plant model which simulates the operation of the entire plant including the control device; a step of updating the control parameter used for calculating the control command value in the plant model, on the basis of an objective function calculated based on a calculation result of the process quantity in the plant model; and a step of calculating a clearance between a stationary member and a rotating member in the rotating machine, on the basis of the process quantity from the plant model. The method includes searching for an optimal control parameter within a range where the calculated clearance satisfies a constraint condition.

### Advantageous Effects

The present disclosure provides a control parameter optimization device or the like that can search for an optimal control parameter within a range where the clearance between the stationary member and the rotating member in the rotating machine satisfies a constraint condition.

### BRIEF DESCRIPTION OF DRAWINGS

FIG. 1 is a block diagram schematically showing a configuration of a plant according to an embodiment.

FIG. 2 is a block diagram schematically showing a configuration of a plant according to an embodiment.

FIG. 3 is a block diagram showing a functional configuration of a control parameter optimization device according to an embodiment.

FIG. 4 is a block diagram schematically showing a configuration of a control parameter optimization device according to an embodiment.

FIG. 5 is a graph for describing an example of optimization by the control parameter optimization device according to an embodiment.

FIG. 6 is a graph for describing an example of optimization by the control parameter optimization device according to an embodiment.

FIG. 7 is a graph for describing an example of optimization by the control parameter optimization device according to an embodiment.

FIG. 8 is a graph for describing an example of optimization by the control parameter optimization device according to an embodiment.

FIG. 9 is a flowchart showing steps of a control parameter optimization method according to an embodiment.

### DETAILED DESCRIPTION

Embodiments will now be described in detail with reference to the accompanying drawings. It is intended, however, that unless particularly specified, dimensions, materials, shapes, relative positions and the like of components described in the embodiments shall be interpreted as illustrative only and not intended to limit the scope of the present invention.

For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, for instance, an expression of a shape such as a rectangular shape or a cylindrical shape shall not be construed as only the geometrically strict shape, but also includes a shape with unevenness or chamfered corners within the range in which the same effect can be achieved.

On the other hand, an expression such as “comprise”, “include”, “have”, “contain” and “constitute” are not intended to be exclusive of other components.

### Configuration of Plant

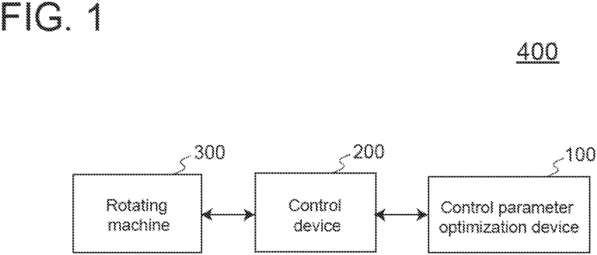

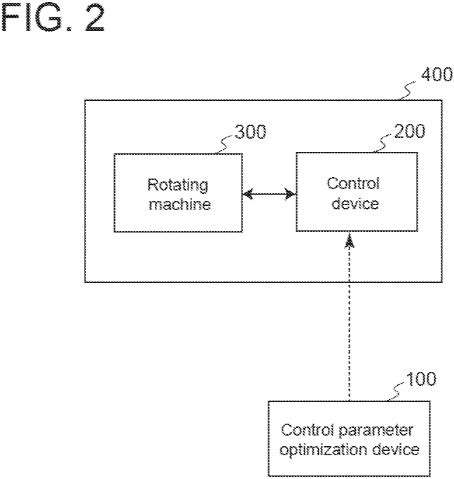

A configuration of a plant 400 according to an embodiment of the present disclosure will now be described with reference to FIG. 1. FIG. 1 is a block diagram schematically showing the configuration of the plant 400 according to an embodiment. FIG. 2 is a block diagram schematically showing the configuration of the plant 400 according to an embodiment.

For example, as shown in FIG. 1, the plant 400 includes a rotating machine 300, a control parameter optimization device 100, and a control device 200 configured to control the operation on the basis of a set control parameter. The control parameter set in the control device 200 is optimized by the control parameter optimization device 100. The control device 200 is configured to control various devices (including the rotating machine 300) constituting the plant 400. The control parameter optimization device 100 may be incorporated in the control device 200 and integrated with the control device 200.

In an embodiment, the control parameter optimization device 100 may be not integrated with the control device 200, but may be a separate body. Further, in an embodiment, the control parameter optimization device 100 may be in a remote location from the plant 400. In this case, the control parameter optimization device 100 is connected online to the control device 200 of the plant 400, and an output of the control parameter optimization device 100 is transmitted to the control device 200 via a network.

Alternatively, in an embodiment, for example, as shown in FIG. 2, the control parameter optimization device 100 and the plant 400 may be offline. In this case, an output of the control parameter optimization device 100 is stored in a storage medium such as a USB memory or is printed and collected in a report (paper medium), and the storage medium or paper medium is passed to the plant 400. The dotted arrow in FIG. 2 means that data may be transferred or manually input by a person. In other words, the control parameter optimization device 100 can be used as an independent device, and an operator may set an output result of the optimized control parameter in the control device 200.

The rotating machine 300 is a machine rotated by a working fluid (e.g., steam, combustion gas), and may be, for example, a gas turbine or a steam turbine. Since a compressor is not rotated by a working fluid, it is excluded from the rotating machine 300 referred to here. The plant 400 may be a gas turbine combined cycle power generation plant (GTCC), and may be provided with two or more rotating machines 300.

### Functional Configuration of Control Parameter Optimization Device

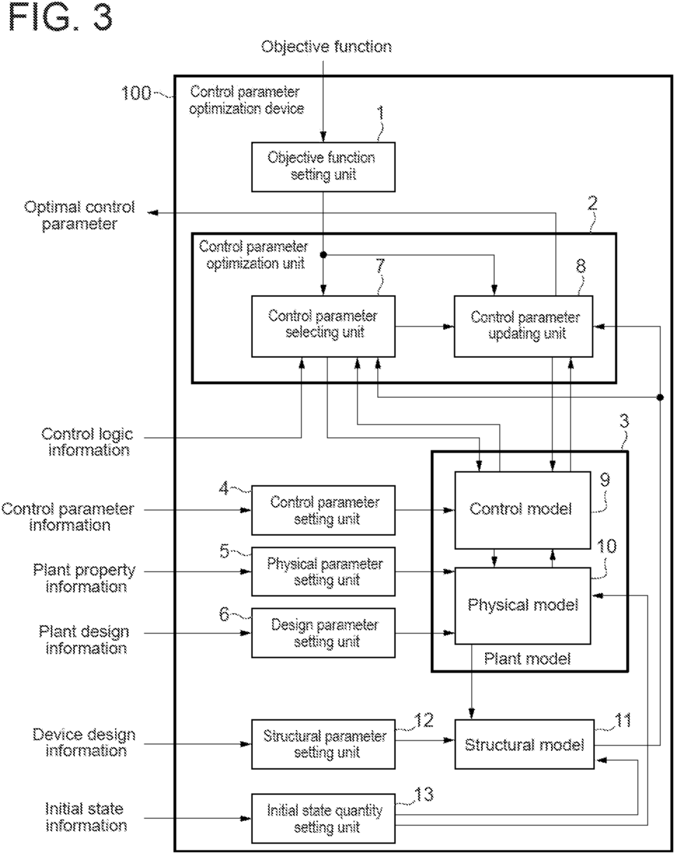

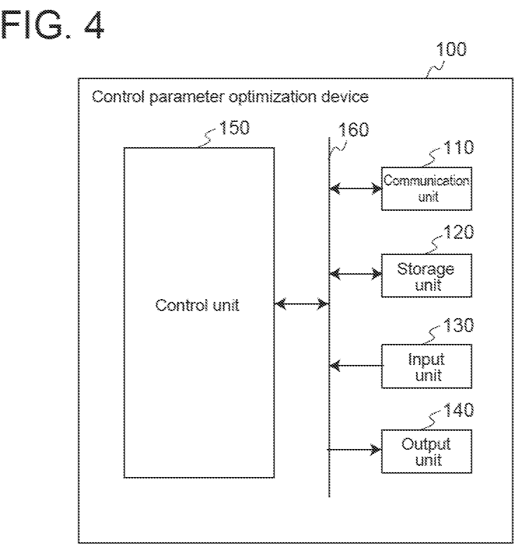

FIG. 3 is a block diagram showing a functional configuration of the control parameter optimization device 100 according to an embodiment. FIG. 4 is a block diagram schematically showing a configuration of the control parameter optimization device 100 according to an embodiment.

First, the functional configuration of the control parameter optimization device 100 will be described with reference to FIG. 3. The control parameter optimization device 100 includes an objective function setting unit 1, a control parameter optimization unit 2, a plant model 3, a control parameter setting unit 4, a physical parameter setting unit 5, a design parameter setting unit 6, a structural model 11, a structural parameter setting unit 12, and an initial state quantity setting unit 13.

The objective function setting unit 1 sets an objective function input by an operator in the control parameter optimization unit 2. The objective function referred to here is an improvement item (start-up time, shut-down time, load change rate, device lifetime consumption, fuel cost, power generation efficiency, etc.) in the operation control of the plant 400, and is defined by a function of a process quantity of the plant 400. The number of objective functions input to the objective function setting unit 1 may be one or more than one. As the method of inputting the objective function to the objective function setting unit 1, a list of objective functions may be stored in advance in a storage unit 120 (see FIG. 4) of the control parameter optimization device 100, and an operator may select an objective function to be optimized from this list.

The control parameter optimization unit 2 includes a control parameter selecting unit 7 which selects a control parameter used for optimization based on the objective function from control parameters of the plant 400, and a control parameter updating unit 8 which adjusts the value of the control parameter selected by the control parameter selecting unit 7.

The plant model 3 is a model configured to simulate the operation of the entire plant 400 including the control device 200, and calculate a control command value by the control device 200 and a process quantity of the plant 400. The plant model 3 includes a control model 9 which simulates the operation of the control device 200, and a physical model 10 which simulates the operation of various devices (e.g., rotating machine 300) of the plant 400 controlled by the control device 200. Each model will be described in detail later.

The structural model 11 is a model for calculating a temperature distribution or a shape displacement distribution of the rotating machine 300, and is configured to calculate a clearance between a stationary member and a rotating member in the rotating machine 300, on the basis of the process quantity calculated by the physical model 10 of the plant model 3. The structural model 11 may be configured to calculate each of the axial clearance and the radial clearance. The structural model 11 may be configured to, for example, acquire a process quantity that indicates the state of the working fluid at the inlet or the outlet of the rotating machine 300 from the plant model 3, and calculate the clearance using this process quantity.

In an embodiment, the structural model 11 is further configured to calculate at least one of the lifetime consumption of the device or the thermal stress generated in the device.

The structural model 11 may be, for example, a model for structural analysis by the finite element method (FEM). The plant model 3 and the structural model 11 may be defined by a combination of a basic model file and model constants. In this case, it is advantageous that the same architecture can be used when the basic configuration of the model changes. For example, it is possible to flexibly respond to changes in the rotating machine 300 and the system configuration.

The control parameter selecting unit 7 extracts control parameters related to the objective function (hereinafter, referred to as “related control parameters” as appropriate) on the basis of control logic information manually input by an operator or acquired from an external device. The control parameter selecting unit 7 may select a control parameter having high sensitivity to the objective function from among the related control parameters as a control parameter to be optimized, and output it to the control parameter updating unit 8. When the clearance calculated by the structural model 11 does not satisfy a constraint condition in the optimization calculation, the control parameter selecting unit 7 may select a control parameter that affects the clearance, and output it to the control parameter updating unit 8.

The sensitivity of the related control parameters to the objective function is obtained by sensitivity analysis using the plant model 3. The control parameter selecting unit 7 selects one or more related control parameters having high sensitivity to the objective function from among the extracted related control parameters as the control parameter to be optimized. The sensitivity of the related control parameters to the objective function may be defined by a ratio of the change amount of the objective function to the change amount of the related control parameter, and may be obtained by changing the value of each related control parameter and inputting it to the plant model 3 and having the plant model 3 calculate the objective function, for example.

The control parameter selecting unit 7 may be configured to display the related control parameter selected as the control parameter to be optimized on a display device (not shown) for confirmation by an operator. Further, the control parameter selecting unit 7 may be configured to display a plurality of related control parameters on a display device (not shown) in descending order of sensitivity and allow an operator to select the control parameter to be optimized from among them.

The control parameter updating unit 8 adjusts the value of the control parameter selected by the control parameter selecting unit 7 so that the objective function set by the objective function setting unit 1 is optimized, and outputs the adjusted optimization control parameter to the control device 200. At this time, the control parameter updating unit 8 may output an optimized objective function (optimal solution) to the display device (not shown). Hereinafter, an example of the procedure for adjusting the value of the control parameter by the control parameter updating unit 8 will be described.

First, the control parameter updating unit 8 sets the control parameter selected by the control parameter selecting unit 7 to a predetermined value as a value used for calculating the objective function, and inputs it to the plant model 3. The plant model 3 calculates the objective function on the basis of the value of the control parameter input from the control parameter updating unit 8, and outputs a calculation result to the control parameter updating unit 8.

The control parameter updating unit 8 adjusts the value of the control parameter so that the calculated value of the objective function output from the plant model 3 is improved (for example, when the objective function is the start-up time, the value is decreased). Specifically, the control parameter updating unit 8 updates the value of the control parameter used for calculating a control command value in the plant model 3 (an output of the control model 9, which will be described later), on the basis of the objective function calculated based on a calculation result of the process quantity in the plant model 3 (an output of the physical model 10, which will be described later). The control parameter updating unit 8 inputs the updated control parameter value to the plant model 3 again, and causes the plant model 3 to calculate the objective function.

In updating of the control parameter, the control parameter updating unit 8 searches for an optimal control parameter within the range where the clearance calculated by the structural model 11 satisfies the constraint condition. Further, the control parameter updating unit 8 updates the control parameter within the range of the operation limit. The operation limit is a limit value different from a limit value of thermal stress or clearance; for example, it is a limit value (upper limit or lower limit) of a process quantity of the plant (lifetime consumption of components, temperature, pressure, load change rate, etc.). The operation limit may include limit values such as the maximum opening increase rate of a valve and the load increase rate of a gas turbine. The control parameter updating unit 8 may be configured to calculate the operation limit on the basis of plant property information and plant design information.

The control parameter updating unit 8 adjusts the value of the control parameter by repeatedly executing the above adjustment procedure once or several times. Here, existing optimization algorithms such as a multipurpose evolutionary algorithm and a sequential quadratic algorithm can be applied to the adjustment of the control parameter value.

In the control device 200 of the plant 400, if the control parameter is not a constant value but is defined as a function of process quantities of the plant 400, for example, the value of the control parameter may be obtained by performing the above adjustment procedure for each of several predetermined process quantities, and a function that complements these values may be used as the control parameter. That is, the control parameter used for calculating the objective function is not limited to the value of the control parameter. The control parameter updating unit 8 is not limited to a configuration for adjusting and updating the value of the control parameter, but is broadly interpreted as a configuration for adjusting or updating the control parameter.

The control parameter setting unit 4 extracts a control parameter necessary for constructing the control model 9 (described later) in the plant model 3 from control parameter information of the plant manually input by an operator or automatically input from an external system, and sets it in the control model 9. The control parameter information referred to here is information on control parameters stored in the control device 200, such as control set values for controlled variables and items, values, upper limit, or lower limit of control gain of the plant 400. As a modification, control logic information of the plant 400 may be input to the control parameter setting unit 4 instead of the control parameter information. In this case, the control parameter setting unit 4 needs to recognize information such as signal lines, state symbols, and numerical values from the input control logic information as a pattern, and extract an item to which a numerical value is given in the control logic, namely, the control parameter and the value thereof, i.e., the control parameter information.

The physical parameter setting unit 5 extracts a physical parameter necessary for constructing the physical model 10 (described later) in the plant model 3 from plant property information manually input by an operator or automatically input from an external system, and sets it in the physical model 10. The plant property information referred to here is information on thermal equilibrium specific to the plant 400, such as temperature of steam generated according to a heat source load of a gas turbine or a boiler, flow rate, pressure, and thermal stress. As a modification, operational data (measurement items and values thereof) of the plant 400 may be input to the physical parameter setting unit 5 instead of the plant property information. In this case, the physical parameter setting unit 5 needs to refer to the input operational data (e.g., temperature, flow rate, pressure of steam corresponding to the heat source load) and extract the value of the physical parameter necessary for constructing the physical model 10.

The design parameter setting unit 6 extracts a design parameter necessary for constructing the physical model 10 in the plant model 3 from plant design information manually input by an operator or automatically input from an external system, and sets it in the physical model 10 (described later) in the plant model 3. The plant design information referred to here is design information specific to the plant 400, such as equipment volume, pipe length, and material of the plant 400.

The structural parameter setting unit 12 extracts a structural parameter necessary for calculating the clearance in the structural model 11 from device design information manually input by an operator or automatically input from an external system, and sets it in the structural model 11. The device design information referred to here is design information specific to the rotating machine 300, such as thermal expansion rate, heat transfer rate, and dimension of the rotating member and the stationary member of the rotating machine 300. The structural parameter is condition information on how to set the heat transfer rate or heat transfer coefficient for process quantities such as pressure and temperature. This heat transfer rate is the heat transfer rate in heat exchange between the working fluid and the stationary member or the rotating member, not the heat transfer rate between the members. When the structural model 11 is read out in a completed state, the structural parameter setting unit 12 may be omitted from the configuration of the control parameter optimization device 100.

Here, when the name of each model parameter extracted by the control parameter setting unit 4, the physical parameter setting unit 5, the design parameter setting unit 6, or the structural parameter setting unit 12 does not coincide with the name of each model parameter registered in the plant model 3 or the structural model 11, the control parameter optimization device 100 may be configured such that model parameters having similar names are displayed on the display device in associated with each other to allow an operator to confirm the suitability of the correspondence. The model parameter referred to here is a general term for parameters set by the control parameter setting unit 4, the physical parameter setting unit 5, the design parameter setting unit 6, and the structural parameter setting unit 12.

The control model 9 is constructed by a table function that converts a process quantity of the plant 400 into a control command value, a function that generates a pulse signal according to the magnitude relationship between a process quantity and a preset threshold, or a combination thereof, and calculates the control command value on the basis of a calculated value of the process quantity of the plant 400 input from the physical model 10, and outputs it to the physical model 10. Further, the control model 9 calculates the objective function on the basis of the process quantity of the plant 400 input from the physical model 10, and outputs it to the control parameter selecting unit 7 and the control parameter updating unit 8.

Here, the plant model 3 may include a plurality of control models 9 corresponding to a plurality of different control methods as a control model library, and may select the control model 9 according to the control method of the plant 400 to be controlled. This makes it possible to apply the control parameter optimization device 100 to the plant 400 having a different control method.

The physical model 10 calculates a process quantity of the plant 400 on the basis of the control command value input from the control model 9, and outputs it to the control model 9. Specifically, the flow rates of fuel and steam and the valve opening corresponding to each flow rate are determined from the input control command value, and the respective temperature, pressure, and flow rate are calculated from the mass balance and heat balance of gas and steam under each flow rate.

Here, the plant model 3 may include a plurality of physical models 10 corresponding to a plurality of different device configurations or a plurality of different types of plants 400 as a physical model library, and may select the physical model 10 according to the device configuration or the type of the plant 400 to be controlled. This makes it possible to apply the control parameter optimization device 100 to the plant 400 having a different device configuration or type.

The initial state quantity setting unit 13 extracts an initial state quantity of the model parameter from initial state information manually input by an operator or automatically input from an external system (e.g., control device 200), and sets it in the physical model 10 and the structural model 11. The initial state information is information on the initial temperature of each part of the rotating machine 300 or the elapsed time after the operation is stopped. The initial state quantity of the model parameter is a measured value or a calculated value (estimated value) of the model parameter at the start of the optimization calculation. The initial state quantity setting unit 13 may be configured to execute a plant shut-down simulation according to an instruction and a condition input by an operator or an external device, and use the simulation result for calculating the initial state quantity.

The functional configuration of the control parameter optimization device 100 has been described with reference to FIG. 3. Although not shown in FIG. 3, the control parameter optimization device 100 may be provided with a configuration that accepts the setting of calculation conditions as information manually input by an operator or input from an external device (e.g., control device 200).

The calculation condition information is used in executing the optimization calculation. The calculation condition information includes, for example, the atmospheric temperature, the shape of the start-up curve (the number of inflexion points), the setting of whether model parameters constituting the start-up curve are fixed or variable in the optimization calculation, the control operation limit, the completion condition of start up or stop of the rotating machine 300, and the designation of the control model 9, the physical model 10, or the structural model 11 to be used. If the model parameters are fixed in the calculation, the number of inflection points is one. The calculation condition information may further include information that specifies the result of the shut-down simulation used for calculating the initial state quantity. The calculation condition information may include multiple patterns of information, and the optimization calculation may be executed for each pattern to select the optimum result from among them.

### Hardware Configuration of Control Parameter Optimization Device

The configuration of the control parameter optimization device 100 will be described with reference to FIG. 4. As shown in FIG. 4, the control parameter optimization device 100 includes a communication unit 110 configured to communicate with another device, a storage unit 120 configured to store various data, an input unit 130 configured to receive an input from an operator, an output unit 140 configured to output information, and a control unit 150 configured to control the entire device. These components are connected to each other by a bus line 160.

The communication unit 110 is a communication interface including a network interface card controller (NIC) for wire communication or wireless communication. The communication unit 110 communicates with another device (e.g., server device or control device 200) via the network.

The storage unit 120 includes, for example, a random access memory (RAM) and a read only memory (ROM). The storage unit 120 stores a program (e.g., plant model 3, structural model 11, and program for executing optimization calculation) for executing various control processing and various data (e.g., input information, setting information, calculation result). The storage unit 120 may be composed of a single storage device, or may be composed of a plurality of storage devices.

The input unit 130 includes, for example, an input device such as an operation button, a keyboard, a pointing device, and a microphone. The input unit 130 is an input interface used for an operator to input instructions or information.

The output unit 140 includes, for example, an output device such as a liquid crystal display (LCD), an electroluminescence (EL) display, and a speaker. The output unit 140 is an output interface for providing information to an operator.

The control unit 150 includes, for example, a processor such as a central processing unit (CPU) and a graphics processing unit (GPU). The control unit 150 controls the operation of the entire device by executing a program stored in the storage unit 120. For example, the control unit 150 realizes the calculation process for the control parameter optimization unit 2 and the structural model 11.

The control parameter optimization device 100 may be configured to acquire information related to the model parameters of the plant 400 (e.g., plant property information, plant design information, device design information, control parameter information) from a server device (not shown) for sharing information on the plant 400 through the communication unit 110. Further, the control parameter optimization device 100 may be configured to acquire such information from an operator through the input unit 130.

The control parameter optimization device 100 may acquire the calculation condition information through the communication unit 110 or the input unit 130. The control parameter optimization device 100 may be configured to display the optimization calculation result on the display device through the output unit 140, or may be configured to output (set) information on the optimized control parameter (optimization control parameter) to the control device 200 through the communication unit 110.

The control parameter optimization device 100 may be configured to use a database storing ID-assigned various information necessary for the optimization calculation. Such a database is stored in, for example, a server device (not shown) which communicates with the control parameter optimization device 100 or the storage unit 120 of the control parameter optimization device 100.

For example, in the database, an operational data ID is assigned by associating information indicating the date and time, information indicating operations such as start up and shut down, unit name, and operational data. A shut-down simulation ID is assigned by associating unit name, used plant model ID, structural model ID, control parameter ID, and shut-down simulation result. The control parameter ID is assigned by associating unit name, information indicating whether it has been set in the actual machine, and information indicating the control parameter setting value. The information indicating the control parameter setting value is information indicating a combination of the parameter corresponding to the initial state of the plant (e.g., metal temperature) and the control parameter.

Further, in the database, the plant model ID is assigned by associating unit name, plant basic model file ID, information indicating whether the parameter adjustment has been done, operational data ID used for the parameter adjustment, model parameter (adjustable parameter) of the plant model 3, model parameter (non-adjustable parameter) of the plant model 3, and information on error. The plant basic model file ID is assigned by associating unit type (information indicating whether the plant is a GTCC or a steam turbine), unit model, and plant model file. An optimization calculation result ID is assigned by associating unit name, used plant model ID, used structural model ID, elapsed time after shut down, constraint condition, control parameter, simulation result, and calculation result of objective function. In an embodiment, the structural model is created for each unit, and the structural model is associated only with the unit name.

The structural model ID is assigned by associating unit name, structure basic model file ID, information indicating whether the parameter adjustment has been done, operational data ID used for the parameter adjustment, model parameter (adjustable parameter) of the plant model 3, model parameter (non-adjustable parameter) of the plant model 3, and information on error. The structure basic model file ID is assigned by associating unit name and plant model file.

Thus, by storing each ID and related information in association with each other in the database, the control parameter optimization device 100 can easily acquire information necessary for the optimization calculation by using each ID as a search key. Further, since information necessary for the optimization calculation for various application targets are stored in the database, and information necessary for the actual application target is extracted from the database, the versatility of the control parameter optimization device 100 for the application target can be improved.

An example of the configuration of the control parameter optimization device 100 has been described with reference to FIG. 4. The control parameter optimization device 100 is not limited to the above-described configuration example. A part of the configuration may be omitted, or another configuration may be added.

Further, the control parameter optimization device 100 is not limited to the above example, and various modifications can be made. For example, the control parameter optimization device 100 may be configured to store information input to the control parameter selecting unit 7, the control model 9, and the physical model 10 in the storage unit 120, and when the control parameter optimization device 100 is applied to another plant 400 of the same type and scale, if a part of information input to the control parameter selecting unit 7, the control model 9, or the physical model 10 is missing, supplement missing data from the past input information stored in the storage unit 120.

### Illustrative Example of Optimization

When one objective function is targeted, a control parameter related to the objective function is selected, and the best solution of the selected control parameter is searched for and optimized. In contrast, when multiple objective functions having a trade-off relationship are targeted, the multi-objective optimization method may be used to search for and optimize the optimal control parameter.

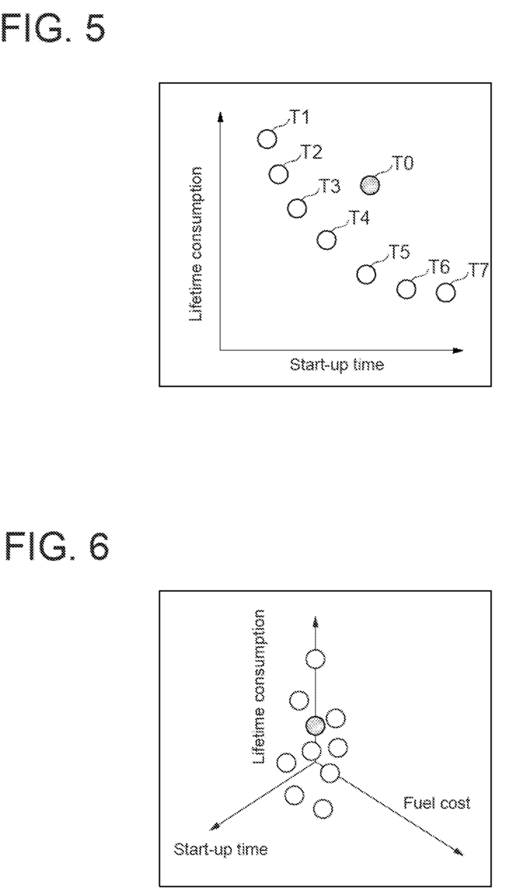

FIGS. 5 to 8 are each a graph for describing an example of optimization by the control parameter optimization device 100 according to an embodiment. Illustrative examples of the optimization will be described with reference to these figures.

First, an example of applying the control parameter optimization device 100 to the search for the optimal start-up curve (start-up schedule) at the time of starting a power plant will be described. In FIG. 5, the start-up time and the lifetime consumption are set as the objective functions, and multiple start-up curves corresponding to the optimal solution are each indicated by “o” (That is, for multiple start-up curves, the start-up time and the lifetime consumption when the power plant is started along each start-up curve are calculated by the plant model (control model, physical model), and all of the multiple start-up curves are plotted on a graph with the horizontal axis representing the start-up time and the vertical axis representing the lifetime consumption). In the plant 400, the start-up time and the lifetime consumption are generally in a trade-off relationship. Therefore, there may be more than one start-up curve corresponding to the optimal solution (hereinafter referred to as the optimal solution). For example, when a known evolutionary algorithm is applied as the multi-objective optimization method in the control parameter updating unit 8, start-up curves T1 to T7 are calculated as the optimal solution to the start-up curve T0 before optimization. As shown in FIG. 5, the control parameter optimization device 100 may be configured to display the start-up curve T0 before optimization together with the optimal solutions T1 to T7 on the display device. In this case, an operator can confirm the improvement effect on the objective functions (start-up time and lifetime consumption) by the optimization.

FIG. 6 shows a display example of the optimal solutions when the start-up time, the lifetime consumption, and the fuel cost are set as the objective functions. If four or more objective functions are set, they may be displayed separately for each of three or less objective functions. For example, if four objective functions are set, they may be divided into three objective functions and one remaining objective function, or two objective functions and two remaining objective functions.

As shown in FIG. 5, the control parameter optimization device 100 may be configured to, when the optimal solutions T1 to T7 are calculated as a result of optimization of the start-up curve, allow one to check multiple start-up schedules corresponding to the optimal solutions on the screen of the display device. The control parameter setting unit 4 may be configured to set in the control device 200 an optimized control parameter corresponding to an optimal solution selected by the operator who sees the display device from among the optimization results (optimal solutions and corresponding optimized control parameters) output from the control parameter optimization device 100. On the other hand, if none of the optimal solutions is selected by the operator, none of the optimization control parameters may be set in the control device 200. Thus, it is possible to reflect one optimal solution, which can realize the desired operational performance, of the optimal solutions calculated by the control parameter optimization device 100 in the actual control of the plant 400.

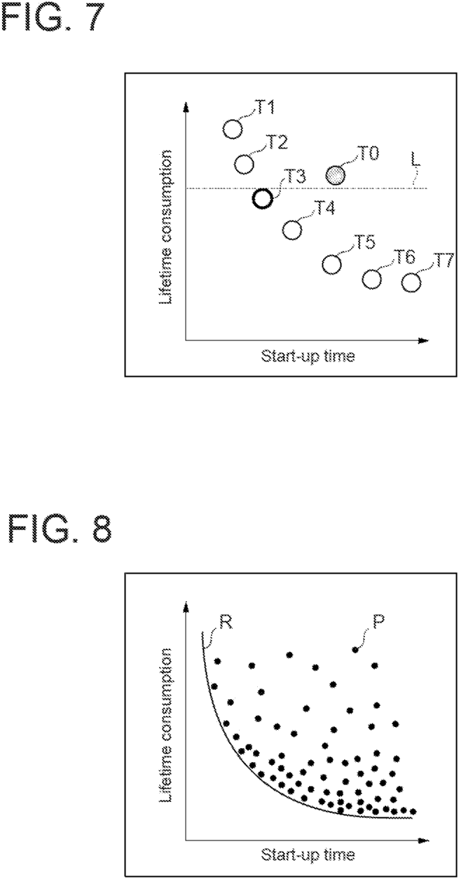

FIG. 7 shows an exemplary relationship between an operation limit L and multiple optimal solutions T1 to T7 when the start-up time and the lifetime consumption are set as the objective functions and the upper limit of the lifetime consumption is set as the operation limit. In the example shown in FIG. 7, the control parameter updating unit 8 selects one of the optimal solutions T3 to T7 that satisfies the operation limit L among the optimal solutions T1 to T7, and outputs the optimized control parameter corresponding to the selected optimal solution to the control device 200. For example, from among the optimal solutions T3 to T7 satisfying the operation limit L, the optimal solution T3 closest to the operation limit L is selected. The method of selecting the optimal solution is not limited to such a selection method, and various selection methods can be considered. For example, from among the optimal solutions T3 to T7 satisfying the operation limit L, an optimal solution that minimizes the weighted average of the start-up time and the lifetime consumption may be selected.

FIG. 8 plots the calculation results obtained for various start-up curves (start-up time and lifetime consumption when started along each start-up curve) on a graph with the horizontal axis representing start-up time and the vertical axis representing lifetime consumption. To obtain such calculation results, first, candidates of a combination of start-up parameter values, such as change rate, retention value, and retention time, which define the start-up curve (schedule of power generation increase) are randomly selected. Then, for each of the selected combination candidates of start-up parameters, the start-up time and the lifetime consumption when the rotating machine 300 is started along the start-up curve defined by the combination of start-up parameter values are calculated for all of the selected combination candidates of start-up parameters. As a result, the calculation results are obtained.

In start up of the rotating machine 300, for example, if an attempt is made to shorten the start-up time, the lifetime consumption increases, i.e., different purposes cannot be improved at the same time. Thus, there is a trade-off relationship between the two purposes.

Each of the plots P indicates the start-up curve. The curve R represents a set of solutions forming the best trade-off relationship. Multiple plots P above the curve R and close to the curve R are selected, and combinations of start-up parameter values forming the start-up curve corresponding to each plot P are used as the candidate group of the optimized control parameter.

The above-described illustrative examples of the optimization are examples when the control parameter optimization device 100 is applied to the operation control of the plant 400 at start up, i.e., when the control parameter is optimized while the plant 400 is stopped (before start up). However, the control parameter optimization device 100 is not limited thereto, and may be configured to sequentially optimize the control parameter during the operation of the plant 400, for example. Further, the optimization by the control parameter optimization device 100 may be applied to the operation control at shut down, instead of the operation control at start up.

### Control Parameter Optimization Method

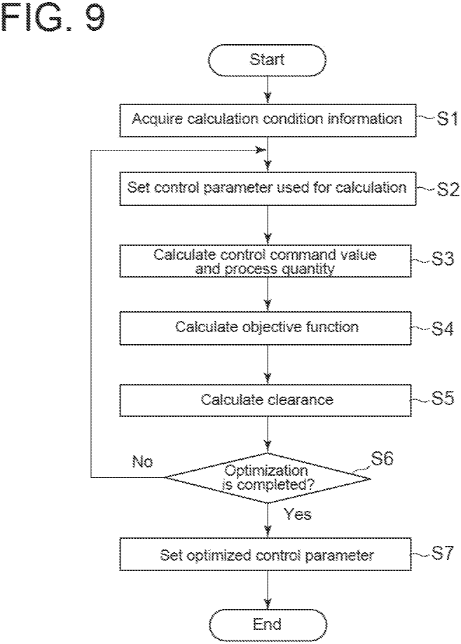

Illustrative examples of the control parameter optimization method will now be described. FIG. 9 is a flowchart showing steps of the control parameter optimization method according to an embodiment. Here, the procedure of the control parameter optimization method will be described as the control process executed by the control parameter optimization device 100. However, a part or the whole of the procedure described below may be performed manually by an operator. In the following description, it is assumed that the model parameters have already been set.

As shown in FIG. 9, the control parameter optimization device 100 acquires calculation condition information (step S1). Specifically, the control parameter optimization device 100 acquires information such as the above-described initial state information, calculation condition, and objective function as the calculation condition information through the communication unit 110 or the input unit 130. When the calculation condition information is stored in the storage unit 120, the control parameter optimization device 100 may acquire the calculation condition information by referring to the storage unit 120. The acquired calculation condition information is used for the calculation in subsequent steps S2 to S5.

The control parameter optimization device 100 sets a control parameter used for the optimization calculation (step S2). For example, the control parameter selecting unit 7 selects a control parameter, and the control parameter updating unit 8 sets a control parameter value used for the optimization calculation. The control parameter updating unit 8 may set a predetermined value as the value of the control parameter at the start of calculation.

The control parameter optimization device 100 calculates a control command value and a process quantity (step S3). Specifically, the control parameter updating unit 8 inputs the control parameter to the plant model 3. The control model 9 and the physical model 10 of the plant model 3 calculate the control command value and the process quantity on the basis of the input control parameter. At this time, the calculation result of the process quantity is output from the physical model 10 to the structural model 11.

The control parameter optimization device 100 calculates an objective function (step S4). Specifically, the plant model 3 calculates the objective function on the basis of the control command value and the process quantity calculated in step S3. The calculation result of the objective function is output to the control parameter updating unit 8.

The control parameter optimization device 100 calculates a clearance between a rotating member and a stationary member of the rotating machine 300 (step S5). Specifically, the structural model 11 calculates the clearance on the basis of the calculation result of the process quantity, and outputs it to the control parameter updating unit 8. The order of step S4 and step S5 may be reversed.

Here, the control parameter optimization device 100 determines whether the optimization is completed (step S6). For example, the control parameter updating unit 8 determines that the optimization is completed when the calculated objective function is minimized or maximized, and the calculated clearance satisfies a constraint condition.

The optimization completion condition is not limited to such a condition. Whether the optimization is completed is determined by whether a preset completion condition is satisfied.

In an embodiment, the control parameter optimization device 100 applies an evolutionary algorithm to search for the optimal control parameter that defines the optimal start-up curve (optimal solution). Specifically, candidates for a combination of start-up parameter values such as change rate, retention value, and retention time are randomly selected and used as the first parent generation. The objective functions (e.g., start-up time and thermal stress) and clearances when the rotating machine 300 is started along the start-up curve corresponding to each of the candidates are calculated for all of the selected combination candidates of start-up parameter values. (Step 1) Each candidate is ranked (evaluated) based on the calculation result, and excellent candidates are extracted from the combination candidates. (Step 2) Next, the processing related to crossover and mutation is performed, and improved candidates (candidate 1′, candidate 2′, candidate 3′, ...) are generated as the offspring generation, so that the number of generations is increased by one. (Step 3) Using the generated improved candidates as the parent generation, steps 1 to 3 are repeated, and it is determined that the optimization is completed when the number of repetitions (number of generations) reaches a preset number of times (number of generations). Multiple candidates (combination of start-up parameter values) that are alive when the optimization is completed are used as the optimized parameters. Further, the start-up curve corresponding to each of the optimized parameters is the optimal solution.

If it is determined that the optimization is not completed (step S6; No), the control parameter optimization device 100 returns to step S2 and performs the processes of steps S2 to S5 again. In step S2 in this case, the control parameter updating unit 8 updates the control parameter and sets the updated control parameter as the control parameter used for the calculation.

Conversely, if it is determined that the optimization is completed (step S6; Yes), the control parameter optimization device 100 sets the optimized control parameter (step S7). Specifically, the control parameter updating unit 8 outputs the optimized control parameter, and the control parameter optimization device 100 sets it in the control device 200.

The present disclosure is not limited to the embodiments described above, but includes modifications to the embodiments described above, and embodiments composed of combinations of those embodiments.

### Conclusion

The contents described in the above embodiments would be understood as follows, for instance.

(1) A control parameter optimization device (100) according to an embodiment of the present disclosure is a device for optimizing a control parameter of a control device (200) for controlling a plant (400) equipped with a rotating machine (300), comprising: a plant model (3) configured to simulate the operation of the entire plant (400) including the control device (200) and calculate a control command value by the control device (200) and a process quantity of the plant (400); a control parameter updating unit (8) configured to update the control parameter used for calculating the control command value in the plant model (3), on the basis of an objective function calculated based on a calculation result of the process quantity in the plant model (3); and a structural model (11) configured to calculate a clearance between a stationary member and a rotating member in the rotating machine (300), on the basis of the process quantity from the plant model (3). The control parameter updating unit (8) is configured to search for an optimal control parameter within a range where the clearance calculated by the structural model (11) satisfies a constraint condition.

According to the above configuration (1), it is possible to search for an optimal control parameter within a range where the clearance between the stationary member and the rotating member in the rotating machine (300) satisfies a constraint condition. Further, by setting the searched control parameter in the control device (200) of the plant (400), it is possible to reduce the risk of damage to the plant (400).

(2) In some embodiments, in the above configuration (1), the structural model (11) is configured to acquire the process quantity that indicates the state of a working fluid at an inlet or an outlet of the rotating machine (300) from the plant model (3), and use the process quantity to calculate the clearance.

According to the above configuration (2), since the process quantity that indicates the state of the working fluid at the inlet or the outlet of the rotating machine (300) is used, the clearance can be calculated more accurately.

(3) In some embodiments, in the above configuration (1) or (2), the structural model (11) is a model for calculating a temperature distribution or a shape displacement distribution of the rotating machine (300).

According to the above configuration (3), the structural model (11) calculates a temperature distribution or a shape displacement distribution of the rotating machine (300). Thus, the clearance distribution can be estimated, and the optimal control parameter can be searched for within the range where the clearance distribution satisfies the constraint condition. As a result, it is possible to further reduce the risk of damage to the plant (400).

(4) In some embodiments, in the above configuration (3), the structural model (11) is further configured to calculate at least one of lifetime consumption or thermal stress.

According to the above configuration (4), since the structural model (11) calculates at least one of lifetime consumption or thermal stress, it is possible to reduce the risk of damage to the plant (400) more directly.

(5) In some embodiments, in any one of the above configurations (1) to (4), the objective function is a function that indicates an index of one or more of fuel consumption, start-up time, shut-down time, or lifetime consumption.

According to the above configuration (5), the control parameter can be optimized with a function indicating an index that should be minimized or maximized as the objective function.

(6) In some embodiments, in any one of the above configurations (1) to (5), the control parameter optimization device (100) comprises a communication unit (110) and is configured to acquire information related to a model parameter of the plant (400) from a server device for sharing information on the plant (400) through the communication unit (110).

According to the above configuration (6), by sharing information (e.g., plant property information, plant design information, device design information, control parameter information) related to the model parameter of the plant (400) whose operation is to be optimized or a plant (400) similar to this plant (400) with the server device and utilizing it, it is possible to improve the accuracy and versatility of the models (e.g., plant model (3), structural model (11)) of the plant (400).

(7) A plant (400) according to an embodiment of the present disclosure comprises: a rotating machine (300); and a control device (200) for controlling the rotating machine (300). The control device (200) is configured to control the operation on the basis of a control parameter optimized by the control parameter optimization device (100) described in any one of the above (1) to (6).

According to the above configuration (7), it is possible to reduce the risk of damage to the plant (400).

(8) A plant (400) according to an embodiment of the present disclosure comprises: a rotating machine (300); the control parameter optimization device (100) described in any one of the above (1) to (6); and a control device (200) configured to control operation on the basis of a control parameter optimized by the control parameter optimization device (100).

According to the above configuration (8), it is possible to reduce the risk of damage to the plant (400).

(9) A control parameter optimization method according to an embodiment of the present disclosure is a method for optimizing a control parameter of a control device (200) for controlling a plant (400) equipped with a rotating machine (300), comprising: a step of calculating a control command value by the control device (200) and a process quantity of the plant (400) by using a plant model (3) which simulates the operation of the entire plant (400) including the control device (200); a step of updating the control parameter used for calculating the control command value in the plant model (3), on the basis of an objective function calculated based on a calculation result of the process quantity in the plant model (3); and a step of calculating a clearance between a stationary member and a rotating member in the rotating machine (300), on the basis of the process quantity from the plant model (3). The method includes searching for an optimal control parameter within a range where the calculated clearance satisfies a constraint condition.

According to the above method (9), it is possible to search for an optimal control parameter within a range where the clearance between the stationary member and the rotating member in the rotating machine (300) satisfies a constraint condition. In this case, by setting the searched control parameter in the control device (200) of the plant (400), it is possible to reduce the risk of damage to the plant (400).

Reference Signs List

| | |
|---|---|
| 1 | Objective function setting unit |
| 2 | Control parameter optimization unit |
| 3 | Plant model |
| 4 | Control parameter setting unit |
| 5 | Physical parameter setting unit |
| 6 | Design parameter setting unit |
| 7 | Control parameter selecting unit |
| 8 | Control parameter updating unit |
| 9 | Control model |
| 10 | Physical model |
| 11 | Structural model |
| 12 | Structural parameter setting unit |
| 13 | Initial state quantity setting unit |
| 100 | Control parameter optimization device |
| 110 | Communication unit |
| 120 | Storage unit |
| 130 | Input unit |
| 140 | Output unit |
| 150 | Control unit |
| 160 | Bus line |
| 200 | Control device |
| 300 | Rotating machine |
| 400 | Plant |

1. A control parameter optimization device for optimizing a control parameter of a control device for controlling a plant equipped with a rotating machine, comprising:
a plant model configured to simulate operation of the entire plant including the control device and calculate a control command value by the control device and a process quantity of the plant;
a control parameter updating unit configured to update the control parameter used for calculating the control command value in the plant model, on the basis of an objective function calculated based on a calculation result of the process quantity in the plant model; and
a structural model configured to calculate a clearance between a stationary member and a rotating member in the rotating machine, on the basis of the process quantity from the plant model,
wherein the control parameter updating unit is configured to search for an optimal control parameter within a range where the clearance calculated by the structural model satisfies a constraint condition.

2. The control parameter optimization device according to claim 1,
wherein the structural model is configured to acquire the process quantity that indicates a state of a working fluid at an inlet or an outlet of the rotating machine from the plant model, and use the process quantity to calculate the clearance.

3. The control parameter optimization device according to claim 1,
wherein the structural model is a model for calculating a temperature distribution or a shape displacement distribution of the rotating machine.

4. The control parameter optimization device according to claim 3,
wherein the structural model is further configured to calculate at least one of lifetime consumption or thermal stress.

5. The control parameter optimization device according to claim 1,
wherein the objective function is a function that indicates an index of one or more of fuel consumption, start-up time, shut-down time, or lifetime consumption.

6. The control parameter optimization device according to claim 1, comprising a communication unit,
wherein the control parameter optimization device is configured to acquire information related to a model parameter of the plant from a server device for sharing information on the plant through the communication unit.

7. A plant, comprising:
a rotating machine; and
a control device for controlling the rotating machine,
wherein the control device is configured to control operation on the basis of a control parameter optimized by the control parameter optimization device according to claim 1.

8. A plant, comprising:
a rotating machine;
the control parameter optimization device according to claim 1; and
a control device configured to control operation on the basis of a control parameter optimized by the control parameter optimization device.

9. A control parameter optimization method for optimizing a control parameter of a control device for controlling a plant equipped with a rotating machine, comprising:
a step of calculating a control command value by the control device and a process quantity of the plant by using a plant model which simulates operation of the entire plant including the control device;
a step of updating the control parameter used for calculating the control command value in the plant model, on the basis of an objective function calculated based on a calculation result of the process quantity in the plant model; and
a step of calculating a clearance between a stationary member and a rotating member in the rotating machine, on the basis of the process quantity from the plant model,
wherein the method includes searching for an optimal control parameter within a range where the calculated clearance satisfies a constraint condition.
